(19) United States
(12) Patent Application Publication
(10) Pub. No.: US 2010/0211404 A1
(43) Pub. Date: Aug. 19, 2010

(54) Methods and Systems for Real-Time RRi Values PD2i of Heartbeat Intervals

(75) Inventors: James E. Skinner, Bangor, PA (US); Daniel N. Weiss, Boca Raton, FL (US)

Correspondence Address: PATENT CORRESPONDENCE;ARNALL GOLDEN GREGORY LLP, 171 17TH STREET NW, SUITE 2100, ATLANTA, GA, 30363, US

(73) Assignee: Nonlinear Medicine, Inc., Boca Raton, FL (US)

(21) Appl. No.: 12/707,517

(22) Filed: Feb. 17, 2010

Related U.S. Application Data
(60) Provisional application No. 61/153,245, filed on Feb. 17, 2009.

(51) Int. Cl. G06Q 50/00; G06N 5/02; G06F 17/30

(52) U.S. Cl. 705/2; 706/54; 707/736; 707/E17.044

(57) ABSTRACT

Biological outcomes are detected and/or predicted by analyzing biological data containing R-R intervals (RRi). The biological data can be analyzed by performing nonlinear analysis. The biological data can be analyzed when there is minimal noise in the data. The noise in the biological data is minimal before the data is converted to real-time or after the data has been manipulated.

### I. CROSS-REFERENCE TO RELATED APPLICATIONS

This application claims benefit to U.S. Provisional Application No. 61/153,245, filed on Feb. 17, 2009, and is hereby incorporated herein in its entirety.

### II. BACKGROUND

The present methods and systems are directed to evaluating biological or physical data. More particularly, the present systems and methods are directed to evaluating biological or physical data for detecting and/or predicting clinical outcomes.

The recording of electrophysiological potentials has been available to the field of medicine since the arrival of the string galvanometer. Since the 1930's, electrophysiology has been useful in diagnosing cardiac injury and cerebral epilepsy.

The state-of-the-art in modern medicine shows that analysis of R-R intervals (RRi) values observed in the electrocardiogram or of spikes seen in the electroencephalogram can detect and/or predict future clinical outcomes, such as sudden cardiac death or epileptic seizures. Such analysis and predictions are statistically significant when used to discriminate outcomes between large groups of patients who either do or do not manifest the predicted outcome, but known analytic methods are inaccurate when used for individual patients. This general failure of known analytic measures is attributed to the large numbers of false predictions; i.e., the measures have low statistical sensitivity and specificity in their predictions.

Often it is known that something “pathological” is going on in a biological system under study, however, currently available analytical methods are not sensitive, specific or accurate enough to permit the available methods to be useful for individual patients.

It is known that nonlinear analysis of certain biological and physical data increases the accuracy of the analysis over linear analysis; see for example, U.S. Pat. No. 7,276,026, herein incorporated by reference at least for information related to nonlinear analysis. However, under certain circumstances even nonlinear analysis does not always produce reliable and accurate data.

The inaccuracy of nonlinear analysis described in the art, as disclosed herein, are often due to the sensitivity to noise in the data found in methods disclosed in the art. This sensitivity can cause the analysis to become inaccurate and thus may be a priori rejected by these methods.

There are several types of nonlinear analytic tools as described below. Many theoretical descriptions of dimensions are known, such as “D0” (Hausdorff dimension), “D1” (information dimension), and “D2” (correlation dimension).

D2 enables the estimation of the dimension of a system or its number of degrees of freedom from an evaluation of a sample of data generated. Several investigators have used D2 on biological data. However, it has been shown that the presumption of data stationarity cannot be met.

Another theoretical description, the Pointwise Scaling Dimension or “D2i”, has been developed that is less sensitive to the non-stationarities inherent in data from the brain, heart or skeletal muscle. This is perhaps a more useful estimate of dimension for biological data than the D2. However, D2i still has considerable errors of estimation that might be related to data non-stationarities.

A Point Correlation Dimension algorithm (PD2) has been developed that is superior to both the D2 and D2i in detecting changes in dimension in non-stationary data (i.e., data made by linking subepochs from different chaotic generators).

An improved PD2 algorithm, labeled the “PD2i” to emphasize its time-dependency, has been developed. This uses an analytic measure that is deterministic and based on caused variation in the data. The algorithm does not require data stationarity and actually tracks non-stationary changes in the data. Also, the PD2i is sensitive to chaotic as well as non-chaotic, linear data. The PD2i is based on previous analytic measures that are, collectively, the algorithms for estimating the correlation dimension, but it is insensitive to data non-stationarities. Because of this feature, the PD2i can predict clinical outcomes with high sensitivity and specificity that the other measures cannot.

The PD2i algorithm is described in detail in U.S. Pat. Nos. 5,709,214 and 5,720,294, hereby incorporated by reference at least for anything related to the PD2i algorithm and its uses. For ease of understanding, a brief description of PD2i and comparison of this measure with others are provided below.

### III. SUMMARY

The objects, advantages and features of the methods disclosed herein will become more apparent when reference is made to the following description taken in conjunction with the accompanying drawings.

According to exemplary embodiments, clinical outcomes are detected and/or predicted by reducing noise in data that is analyzed using nonlinear analysis wherein the data from the analysis is used to detect and/or predict clinical outcomes. The data is produced by a nonlinear analysis processing routine using an algorithm to produce the data, e.g. PD2i, which is used to detect or predict clinical outcomes. If the data series contains too much noise before the nonlinear analysis the outcome of the analysis can produce inaccurate results. Therefore, one aspect of the disclosed methods and systems is a method and system which reduces the noise in the data series before nonlinear analysis which produces more accurate data which can be used for detecting or predicting the clinical outcomes.

Another aspect of the methods and systems described herein is to perform the nonlinear analysis before noise is amplified into the biological or physical data series.

Another aspect of the methods and systems described herein is to predict cardiac death using the data from the nonlinear analysis on the low level noise data series.

### IV. BRIEF DESCRIPTION OF THE DRAWINGS

FIGS. 1A and 1B shows a schematic of RRi detection. FIG. 1A shows that real-time RRi values can be created by multiplying N, the number of data points (dp) between two successive data points that each contain an R-wave peak, by the sampling period (in “ms/dp”). FIG. 1B shows that rapid heartbeat data, dp counts collected in a search window for 1000-Hz could often miss accurately finding the next R peak because of the setting for the search window for the next beat (i.e., it jumps over the next beat only to detect the second next beat). In this illustration, only the 500-Hz search window captures all of the R peaks accurately and thus, all of the RR intervals. This type of capture error is not the same as the noise in the RRi data, and only serves to illustrate a second source of noise, but one that can be obviated with proper placement of the next-beat search-window. However, to get back to N dp (for PD2i calculations without increasing noise) the real-time dp-values for 500-Hz data must be divided by 2.

FIGS. 2 and 3 show that the PD2i algorithm presumes low noise in the integer values it analyzes. Any noise is multiplied when the N dp values are multiplied by the sampling period (sp) when real-time values are given for the RRi. Noise is ×1 for 1000-Hz data in real-time, ×2 for 500-Hz data in real-time, and ×5.34 for 187-Hz data in real-time. To get back to N dp (low noise), for PD2i analysis, the real-time 500-Hz data is divided by 2 (i.e., sp) and real-time 187-Hz data in divided by 5.345 (i.e., sp) before the PD2i analysis. FIGS. 2 and 3 illustrate the noise-effect of multiplying N dp by sp. In FIG. 2, the ordinate in the upper left panel shows the number of data points between each successive R wave (i.e., not multiplied by the sampling period). The mean and % N suggest low PD2i values and low noise, respectively.

FIG. 3 shows results of the PD2i analysis of R-R intervals when the PD2i analysis is performed after the RR intervals (N dp) are each multiplied by a factor (e.g., sample period, sp) to bring the values back to real-time intervals. There is a large difference in the Min PD2i (the usual clinical value for the file), 2.84 v. 0.96, and the % N, 36.55 v. 64.97, compared to FIG. 2. This difference shows that there is more noise in the data file in FIG. 3 when the RRi is brought to real-time intervals compared to before the data file was brought to real-time intervals. Also there has been a large reduction in the % N, indicating an increase in noise in the data file.

### V. DETAILED DESCRIPTION OF THE INVENTION

An electrocardiogram (ECG or EKG) monitors electrical activity of, for example, the heart. An electrocardiogram (ECG) is taken in analog form. When the ECG monitors the electrical activity of the heart it includes typically a QRS complex. The QRS complex corresponds to the ventricle depolarization. It typically includes a Q wave, an R wave, and an S wave. A Q wave is the initial phase of downward deflection and corresponds to the initial depolarization. The R wave is the positive inflection following the Q wave, and the S wave is the negative deflection following the R wave in normal ECGs. An RR interval is the time or the space between two successive R waves, such as the time between the peaks. This RR interval should occur once for each beat of the heart, and therefore, the time between R waves can be used to produce an R-R series or a heart rate. When taking the analog signal of the ECG and turning it into a digital signal, it must be done at particular rate, Hz, i.e. the data making up the continuous analog curve of the QRS complex through to the next QRS complex is broken into, for example, 187 data points or 500 data points or 1000 datapoints, which corresponds to a 187-, 500-, and 1000-Hz respectively. To get to a time interval in a digital environment, the cycle rate is multiplied by a factor to bring it to a 1000 milliseconds, which approximates the scale of most human heart beats, i.e. 1 beat per second, or 60 beats per minute. Once this conversion is made, the Hz rate multiplied by the conversion factor, this is the real-time RRi data.

In certain methods and systems the PD2i algorithm is used to analyze nonlinear data, including variation, including in certain systems and methods, variation in the RR intervals, which is disclosed in for example, U.S. Pat. No. 7,276,026 for “Method and system for detecting and/or predicting cerebral disorders” to Skinner, U.S. Pat. No. 7,076,288 for “Method and system for detecting and/or predicting biological anomalies to Skinner, U.S. Pat. No. 5,720,294 for “PD2I electrophysiological analyzer” to Skinner, and U.S. Pat. No. 5,709,214 for “PD2i electrophysiological analyzer” to Skinner, as well as PCT Publication No. WO 2008/028004 for “Automated Noise Reduction System for Predicting Arrhythmic Deaths by Skinner and PCT Publication No. WO 2006/076543 for “Knowledge Determination System” to Skinner, all of which are incorporated by reference herein in their entireties at least for material related to PD2i and its use in biological systems.

The model for the PD2i is C(r,n,ref*,) scales as R expPD2i, where ref* is an acceptable reference point from which to make the various m-dimensional reference vectors, because these will have a scaling region of maximum length PL that meets the linearity (LC) and convergence (CC) criteria. Because each ref* begins with a new coordinate in each of the m-dimensional reference vectors and because this new coordinate could be of any value, the PD2i's may be independent of each other for statistical purposes.

The PD2i algorithm limits the range of the small log-R values over which linear scaling and convergence are judged by the use of a parameter called Plot Length. The value of this entry determines for each log-log plot, beginning at the small log-R end, the percentage of points over which the linear scaling region is sought.

In non-stationary data, the small log-R values between a fixed reference vector (i-vector) in a subepoch that is, say, a sine wave, when subtracted from multiple j-vectors in, say, a Lorenz subepoch, will not make many small vector-difference lengths, especially at the higher embedding dimensions. That is, there will not be abundant small log-R vector-difference lengths relative to those that would be made if the j-vector for the Lorenz subepoch was instead in a sine wave subepoch. When all of the vector-difference lengths from the non-stationary data are mixed together and rank ordered, only those small log-R values between subepochs that are stationary with respect to the one containing the reference vector will contribute to the scaling region, that is, to the region that will be examined for linearity and convergence. If there is significant contamination of this small log-R region by other non-stationary subepochs, then the linearity or convergence criterion will fail, and that estimate will be rejected from the accepted PD2i mean.

The PD2i algorithm introduced to the art the idea that the smallest initial part of the linear scaling region should be considered if data non-stationarities exist (i.e. as they always do in biological data). This is because when the j-vectors lie in a subepoch of data that is the same species as that the i-vector (reference vector) is in, then and only then will the smallest log-R vectors be made abundantly, that is, in the limit or as data length becomes large. Thus, to avoid contamination in the correlation integral by species of data that are non-stationary with respect to the species the reference vector is in, one should look only at the slopes in the correlation integral that lie just a short distance beyond the “floppy tail” and within the restricted plot length in the small log-R region.

The “floppy tail” is the very smallest log-R range in which linear scaling does not occur due to the lack of points in this part of the correlation integral resulting from finite data length and finite digitization rate. Thus, by restricting the PD2i scaling to the smallest part of the log-R range above the “floppy tail,” the PD2i algorithm becomes insensitive to data non-stationarities. Note that the D2i always uses the whole linear scaling region, which always will be contaminated if non-stationarities exist in the data.

### A. METHODS AND SYSTEMS

Described herein are methods, systems, and computer readable media for reducing noise associated with electrophysiological data for more effectively predicting an arrhythmic death.

Described herein are systems and methods for analyzing the R to R intervals (also called RRi, RR-intervals, R-Rs) of an ECG using the PD2i, along with systems and methods for identifying and manipulating the R to R interval. Typically an ECG is digitized and an algorithm is run to determine the R-wave peaks and the successive number of data points between each pair of R-wave peaks. This provides the count of the number of data points that lie between successive R wave peaks. In some embodiments, the algorithm multiples the data counts by a conversion factor which converts them to real-time in milliseconds. For example, if the ECG data is digitized at 187 Hz there are 187 data points per second. Thus, there may be 185, 192 etc. data points between the R waves. The data points then need to be converted to real-time by multiplying the data point counts by 5.34 (obtained by dividing 1000 milliseconds by 187 Hz) which gives approximately 1000 milliseconds for the heartbeat intervals. Then, the PD2i is performed on the “milliseconds.” The PD2i analyzes the variation between the R wave peaks. Hence, if all RRi intervals were at 1000, then there would be no variation and the PD2i would be equal to zero. As disclosed herein, a patient with low PD2i values has a greater risk for an event of a clinical outcome (i.e. sudden cardiac death) compared to a patient with high PD2i values. Thus, the higher PD2i value and variation between the RRi the less likely the patient is to have a bad clinical outcome (e.g., sudden cardiac death). This leads to the general conclusion that variation is good and low variation or no variation is bad, with respect to biological outcomes.

Increased noise in the data can lead to inaccurate PD2i analysis; hence, data can be misinterpreted and the accuracy of predicting or detecting clinical outcomes decreases.

Therefore, the noise in data should always be minimized before performing a PD2i analysis.

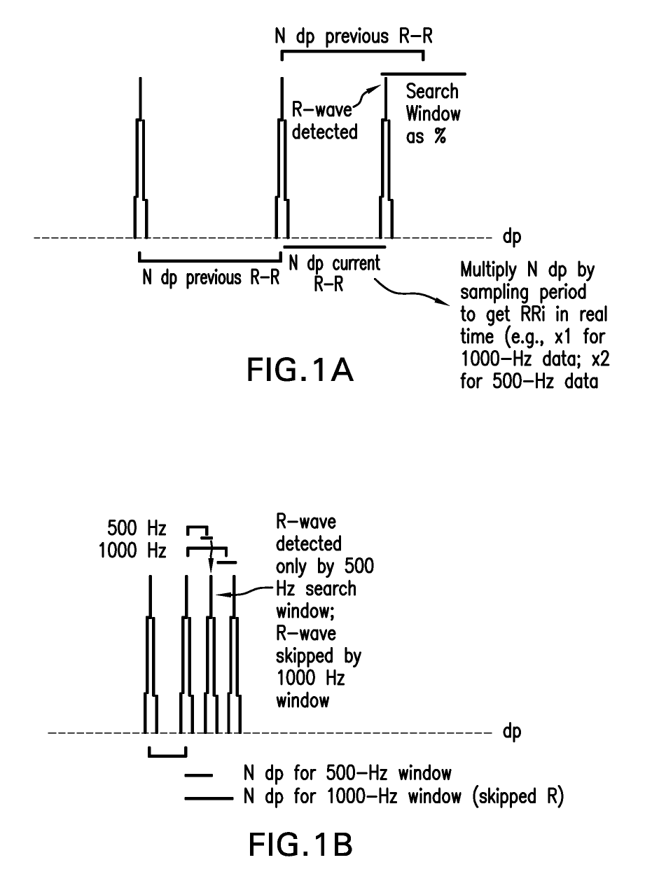

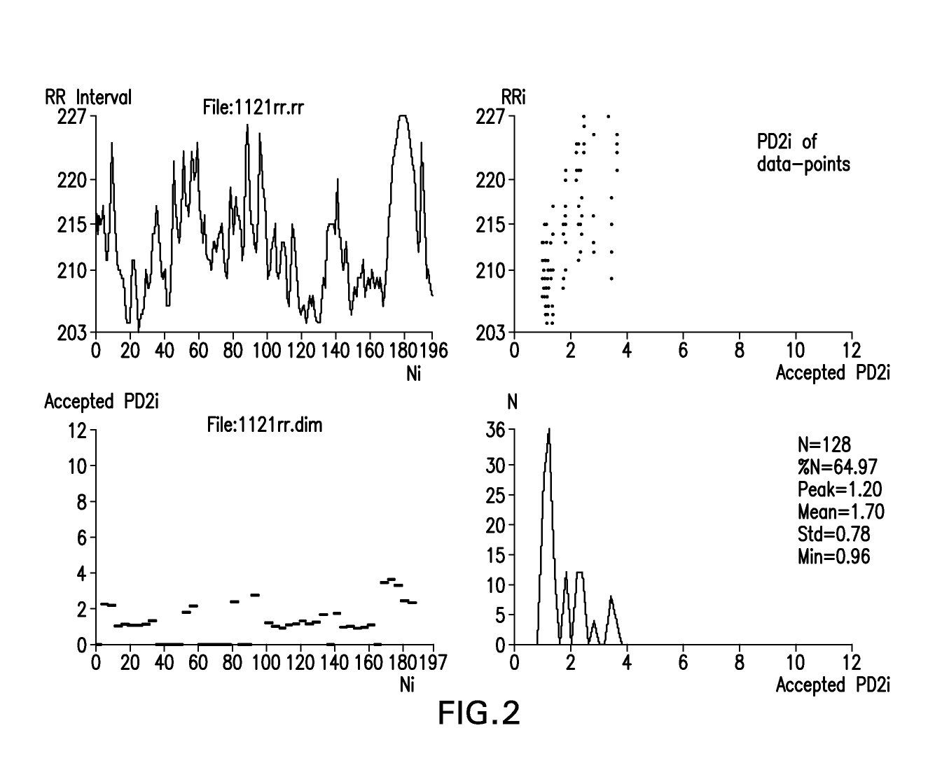

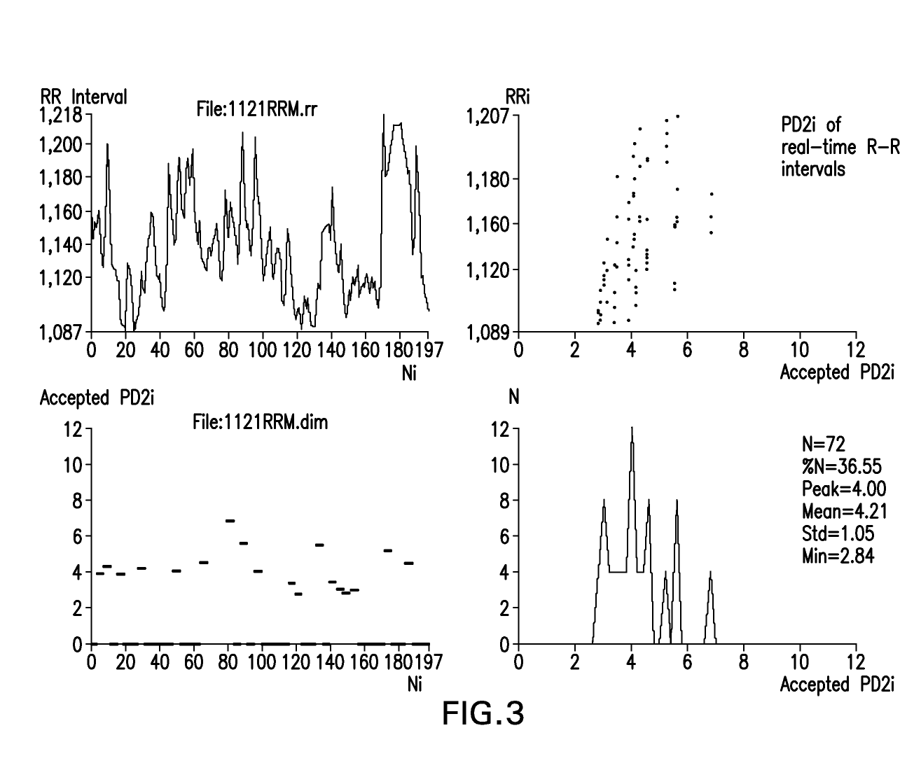

The general formula for determining how to decrease the noise before performing the PD2i analysis is to identify RRi calculations where the quantity (N dp) is multiplied by the sp to get the real-time RR-intervals. Thus, if data is obtained at 187-Hz digitization rate, then in certain embodiments disclosed herein, the RRi values (which are in milliseconds) is divided by the sp (i.e., 5.345). In one example, illustrated in FIG. 1B, where the R-wave peaks are too rapid for the search window set to detect the next beat, the search window can be changed by setting sp=2 to obtain the proper N dp counts, but then one must remember that the real-time RRi values will be 2× too large and should be corrected, accordingly. The “N dp” is the value for each R-R interval that will provide the minimum noise and most accurate PD2i as illustrated by comparison of FIGS. 2 and 3. The PD2i calculation should be done on data point count (N(dp)) not real-time RR values (milliseconds).

The noise correction algorithm disclosed in U.S. Pat. No. 7,276,026 for “Method and system for detecting and/or predicting cerebral disorders” to Skinner, and U.S. Pat. No. 7,076,288 for “Method and system for detecting and/or predicting biological anomalies” reduces this noise by reducing the amplitude of the R wave to half. This increases the specificity of the PD2i calculation.

Disclosed herein are methods and systems where the PD2i is not run on RR intervals of millisecond units, but rather on the count of data points between the R waves. It is disclosed herein that multiplying the number increases the noise.

Noise should always be kept to a minimum in data files analyzed by PD2i. This concept could be applied every time PD2i analysis is performed.

Comparing FIGS. 2 and 3 they show that the real-time values (FIG. 3) have the % N value approach the limit of 30%, which could, if exceeded, result in the a priori rejection of a lot of files because of noise content (see paragraph 44 below). In contrast, analysis of data point counts between beats shows a PD2i with a relatively high % N. The high % N is a result of the low noise caused by not making the data into the real-time data by multiplying the data with the real-time conversion factor (i.e., 5.345 in the case of 187-Hz data).

Disclosed herein are methods and systems of using nonlinear analysis on the data points between beats before and not after they have been multiplied by the real-time factor, as that only increases the noise in the data stream. The noise is already increased because of the descretization error. The descretization error increases as the digitization rate decreases.

According to exemplary embodiments, methods and systems have been developed to reduce or eliminate noise in real-time R-R intervals (RRi) values to nonlinear analytical measures, using PD2i, wherein the data is only available in real-time RRi values. In certain embodiments, a method for calculating the PD2i of heartbeat intervals has been developed when data is only available in real-time RRi values.

The R-R interval refers to the actual number of milliseconds that occurred between the successive heartbeats when the original digital recording of the data was made. For example, if the heart beat was once per second (60 b/m) and the data were digitized at 1000 Hz, 500 Hz or 187 Hz, the R-R intervals would be the count of data points between R-waves times a factor that depends on the digitization rate:

R-R=1000 data points×1000msec/1000dp=1000msec(for 1000Hz digitization), or

R-R=500 data points×1000msec/500dp=1000msec(for 500Hz digitization), or

R-R=187 data points×1000msec/187dp=1000msec(for 187Hz digitization).

The overall noise is caused in part by descretization error which increases as the digitization rate decreases. The Descritization error is related to the sample period, and the sample period value may be unknown. The descretization error is specifically caused by the sample-and-hold digitization of the data and the consequent uncertainty of the peak location within the dp where it occurs and combined with the fact that there are two R wave peaks to make one interval. For example:

Descretization error=2/1000=0.002 for 1000Hz data

Descretization error=2/500=0.004 for 500Hz data

Descretization error=2/187=0.0100 for 187Hz data

PD2i analysis of the R-R intervals is traditionally performed on the real-time RRi values. The real-time RRi values are generated by multiplying the number of data points between two successive R-waves with a factor that is dependent on the digitization rate. For example, if the RRi values were taken at 187 Hz the factor or sampling period that is multiplied by the N×dp counts is determined by, 1000 Hz/187 Hz=5.345. Thus, the noise is enhanced in the data series by a factor of 5.345 and the PD2i analysis can become inaccurate. Many R-R interval detectors work by counting the number of data-points between R-wave peaks and then multiplying them by a factor that is dependent on the digitization rate to bring the values to the real-time.

Conventional nonlinear analysis, for example using the PD2i algorithm, of real-time RRi values takes place after the number of data point values has been multiplied by the sampling period, e.g. 1× for 1000 Hz, 2× for 500 Hz, and 5.345× for 187 Hz. The direct result of the multiplication is an increase in the level of noise in the data file. However, nonlinear analysis, such as PD2i, assumes a low level noise as it performs the analysis. This type of nonlinear analysis therefore increases the noise in the data stream which is already increased due to the descretization error going up as the digitization rate goes down. A result of the high level of noise from the analysis can potentially lead to misrepresentation or a priori rejection of the data which can lead to an inaccurate analysis.

The methods and system described here in eliminates the increases of noise so that nonlinear analysis, using PD2i algorithm, can more accurately analyze real-time RRi values.

In some embodiment, the methods and system described divides the real-time values with the sampling period before the nonlinear, PD2i, analysis is performed so that the analysis is performed only on the lowest level of noise in the data. Thus, by dividing the real-time values (data point values multiplied by the sampling period) with the sampling period, the data point values becomes yet again the lowest level noise in the data.

Also described herein are methods and systems of analyzing real-time R-R intervals (RRi) values to nonlinear analytical measures, using PD2i. As described previously conventional nonlinear analysis, for example using the PD2i algorithm, of real-time RRi values takes place after the number of data point values has been multiplied by the sampling period, e.g. 1× for 1000 Hz, 2× for 500 Hz, and 5.345× for 187 Hz. Also, described herein are methods and systems where the data undergoes PD2i nonlinear analysis before the data is converted to real-time data by multiplying the data by the sampling period. Thus, the nonlinear analysis is performed between the RRi data-point count values rather than after the multiplication by the sampling period. FIG. 2 shows the result of PD2i analysis of counts of data points between the heartbeats, while FIG. 3 shows the result of PD2i analysis after multiplication of the data-point counts by the sampling period, which brings values back to the real-time intervals. There are large differences in Min, Mean, % N values for the two types of PD2i analysis. The decrease of % N in FIG. 3 compared to FIG. 2 indicates an increased level of noise in the data file. Furthermore, the real-time values of % N approach 30%, which, if any lower, could result in a priori rejection of the data file because of the high level of noise content in the data file. The 30% criterion for % N is based on the findings that, 1) data generated by the Lorenz equations are noise-free; 2) systematically adding continuous random (white) noise to Lorenz-data will result in its randomized-phase-surrogate no longer being statistically significantly different; 3) systematically adding continuous random (white) noise to Lorenz-data will result in rejection of more PD2i values (reduction of % N) due to failure to meet the linearity and convergence criteria; and 4) the covariation of the statistical significance of the randomized phase surrogate and the reduction in % N indicates that p>0.05 occurs when % N<30. In contrast, the analysis of data-point counts between heartbeats shows a relatively high % N which would result in a more accurate analysis compared to the real-time values.

Described herein are methods of determining and predicting clinical outcomes by determining if the PD2i value is larger or smaller than 1. A PD2i value smaller than one indicates low variation in the RRi. A PD2i value larger than one indicates a relatively higher variation in the RRi. A PD2i value below one indicates more dire clinical outcomes while a PD2i value above one indicates less dire clinical outcomes.

Disclosed are methods of detecting or predicting clinical outcomes, comprising the steps of: a) Obtaining real-time R-R interval (RRi) values in milliseconds, b) Producing a first data series by dividing the real-time RRi values by the sampling period, c) Analyzing the first data series using nonlinear analysis producing analyzed data; and d) Using the analyzed data to detect or predict clinical outcomes.

Also disclosed are methods of detecting or predicting clinical outcomes, comprising the steps of: a) Obtaining R-R interval (RRi) data points, b) Analyzing the data points using nonlinear analysis to produce analyzed date, before the RRi values are multiplied by the sampling period to become a real-time RRi values in milliseconds, and c) Using the analyzed data to detect or predict clinical outcomes.

Also disclosed are methods to lower the level of noise in data used for detecting or predicting clinical outcomes, comprising the steps of: a) Obtaining R-R interval (RRi) data points, b) Analyzing the data points using nonlinear analysis to produce analyzed data before the RRi interval values are multiplied by the sampling period to become a real-time RRi interval values in values in milliseconds; and c) Using the analyzed data to detect or predict clinical outcomes.

Also disclosed are methods of performing a nonlinear analysis for identification of a clinical state, comprising a) Obtaining R-R interval (RRi) data points, b) Analyzing the R-R interval data points using a nonlinear analysis to produced analyzed data before the RRi data points are converted to real-time RRi values in milliseconds, c) Using the analyzed data to identify a clinical state.

Disclosed are methods, wherein the clinical outcome is cardiac death.

Also disclosed are methods, wherein underlying data for the RRi came from a digitized electrocardiogram (ECG).

Disclosed are methods, wherein the nonlinear analysis comprises analysis with a PD2i algorithm.

Also disclosed are methods, wherein the RRi data is 187 Hz or 500 Hz.

Disclosed are methods, wherein the method is a computer implemented method.

Also disclosed are methods further comprising the step of outputting results from the nonlinear analysis.

Disclosed are methods of analyzing a subject's biological data comprising; receiving a biological record, wherein the record contains an RRi; analyzing the RRi using a nonlinear analysis and outputting results from the nonlinear analysis.

Also disclosed are methods, wherein the method is a computer implemented method, wherein receiving the biological record comprises receiving the biological record from a storage medium, wherein receiving the biological record comprises receiving the record from a computer system, wherein receiving the biological record comprises receiving the record from a biological system, wherein receiving the biological record comprises receiving the biological record via a computer network, wherein the record comprises an ECG record or a respiratory record.

Disclosed are methods of analyzing the variation in biological or physical data of a subject comprising, recommending the performance of any of the methods herein to be performed.

Also disclosed are methods comprising the steps of receiving an output from any of the methods herein and identifying a subject having a nonlinear analysis indicating a biological anomaly.

Disclosed are one or more computer readable media storing program code that, upon execution by one or more computer systems, causes the computer systems to perform any of the methods herein.

Disclosed are computer program product comprising a computer usable memory adapted to be executed to implement the method of the methods herein.

Disclosed are computer programs, comprising a logic processing module, a configuration file processing module, a data organization module, and data display organization module, that are embodied upon a computer readable medium.

Also disclosed are computer program products, comprising a computer usable medium having a computer readable program code embodied therein, said computer readable program code adapted to be executed to implement a method for generating the non-linear analysis, such as a PD2i analysis, of any of the methods disclosed herein, said method further comprising: providing a system, wherein the system comprises distinct software modules, and wherein the distinct software modules comprise a logic processing module, a configuration file processing module, a data organization module, and a data display organization module.

Also disclosed are methods, further comprising a computerized system configured for performing the method and/or further comprising the outputting of the results from the PD2i analysis.

Disclosed are computer-readable media having stored thereon instructions that, when executed on a programmed processor perform the methods of any of the methods disclosed herein.

A system, the system comprising: a data store capable of storing biological data; a system processor comprising one or more processing elements, the one or more processing elements programmed or adapted to: receive biological data comprising RRi; store the biological data in the data store; perform a nonlinear analysis on the biological data before the data is converted to real-time data; and outputting of the results from the nonlinear analysis. In some embodiments, the biological data can be ECG data. In some embodiments, the system can be an ECG system.

Disclosed are systems, wherein the system receives the biological data from a ECG system and/or wherein the system receives the biological data via a computer network. In some embodiments, the biological data can be ECG data. In some embodiments, the system can be an ECG system.

Also disclosed herein are machines, apparati, and systems, which are designed to perform the various methods disclosed herein. It is understood that these can be multipurpose machines having modules and/or components dedicated to the performance of the disclosed methods. For example, a machine can be modified as described herein so that it contains a module and/or component which for example, a) produces a biological record, which creates and identifies one or more biological data series, and performs a nonlinear analysis. In particular, the modules and components within the machine are responsible for determining and predicting clinical outcomes. The modules and/or components analyze the biological data using a nonlinear algorithm as described elsewhere herein. The modules and/or components responsible for identifying and/or manipulating biological data as described elsewhere herein. In some embodiments a machine can be an ECG machine. In some embodiments the biological record can be an ECG record or a respiratory record. In some embodiments the biological data can be ECG data or respiratory data. In some embodiments the biologial data can be blood pressure date, nerve pressure date, or respiratory data. In some embodiments the nonlinear analysis can be performed by the PD2i algorithm.

Thus, the methods and systems herein can have the data, in any form uploaded by a person operating a device capable of performing the methods disclosed herein. The methods can also be associated with the biological records or data as described herein, either incorporated into these systems or being on device which is connected to them.

1. Systems, Machines, and Computer Readable Medium

In addition, or instead, the functionality and approaches discussed above, or portions thereof, can be embodied in instructions executable by a computer, where such instructions are stored in and/or on one or more computer readable storage media. Such media can include primary storage and/or secondary storage integrated with and/or within the computer such as RAM and/or a magnetic disk, and/or separable from the computer such as on a solid state device or removable magnetic or optical disk. The media can use any technology as would be known to those skilled in the art, including, without limitation, ROM, RAM, magnetic, optical, paper, and/or solid state media technology.

### B. DEFINITIONS

Various embodiments of the disclosure will be described in detail with reference to drawings, if any. Reference to various embodiments does not limit the scope of the disclosure, which is limited only by the scope of the claims attached hereto. Additionally, any examples set forth in this specification are not intended to be limiting and merely set forth some of the many possible embodiments for the claimed invention.

1. A

As used in the specification and the appended claims, the singular forms “a,” “an” and “the” or like terms include plural referents unless the context clearly dictates otherwise. Thus, for example, reference to “a pharmaceutical carrier” includes mixtures of two or more such carriers, and the like.

2. Abbreviations

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, “M” for molar, and like abbreviations).

3. About

About modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

4. Analyzed Data

Analyzed data is any data or result that arises from the manipulation of some other form of data, such as RR interval data points or Real-time RR interval values.

5. Biological Record

A biological record or like terms is any collection of biological data. A biological record can be an ECG record.

6. Biological Data

A biological data series or like terms refers to any collection of biological data. A biological data series can be an ECG data series.

7. Clinical Outcomes

A clinical outcome is a documented clinical event, in a subject, such as sudden cardiac death or death. The clinical outcomes can be any outcome, including those disclosed herein.

8. Components

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these molecules may not be explicitly disclosed, each is specifically contemplated and described herein. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

9. Comprise

Throughout the description and claims of this specification, the word “comprise” and variations of the word, such as “comprising” and “comprises,” means “including but not limited to,” and is not intended to exclude, for example, other additives, components, integers or steps.

10. Computer Readable Media, Computer Program Product, Processors, Computer Usable Memory, Computer Systems

In some embodiments, instructions stored on one or more computer readable media that, when executed by a system processor, cause the system processor to perform the methods described above, and in greater detail below. Further, some embodiments may include systems implementing such methods in hardware and/or software. A typical system may include a system processor comprising one or more processing elements in communication with a system data store (SDS) comprising one or more storage elements. The system processor may be programmed and/or adapted to perform the functionality described herein. The system may include one or more input devices for receiving input from users and/or software applications. The system may include one or more output devices for presenting output to users and/or software applications. In some embodiments, the output devices may include a monitor capable of displaying to a user graphical representation of the described analytic functionality.

The described functionality may be supported using a computer including a suitable system processor including one or more processing elements such as a CELERON, PENTIUM, XEON, CORE 2 DUO or CORE 2 QUAD class microprocessor (Intel Corp., Santa Clara, Calif.) or SEMPRON, PHENOM, OPTERON, ATHLON X2 or ATHLON 64 X2 (AMD Corp., Sunnyvale, Calif.), although other general purpose processors could be used. In some embodiments, the functionality, as further described below, may be distributed across multiple processing elements. The term processing element may refer to (1) a process running on a particular piece, or across particular pieces, of hardware, (2) a particular piece of hardware, or either (1) or (2) as the context allows. Some implementations can include one or more limited special purpose processors such as a digital signal processor (DSP), application specific integrated circuits (ASIC) or a field programmable gate arrays (FPGA). Further, some implementations can use combinations of general purpose and special purpose processors.

The environment further includes a system data store (SDS) that could include a variety of primary and secondary storage elements. In one preferred implementation, the SDS would include registers and RAM as part of the primary storage. The primary storage may in some implementations include other forms of memory such as cache memory, non-volatile memory (e.g., FLASH, ROM, EPROM, etc.), etc. The SDS may also include secondary storage including single, multiple and/or varied servers and storage elements. For example, the SDS may use internal storage devices connected to the system processor. In implementations where a single processing element supports all of the functionality a local hard disk drive may serve as the secondary storage of the SDS, and a disk operating system executing on such a single processing element may act as a data server receiving and servicing data requests.

It will be understood by those skilled in the art that the different information used in the systems and methods for respiratory analysis as disclosed herein may be logically or physically segregated within a single device serving as secondary storage for the SDS; multiple related data stores accessible through a unified management system, which together serve as the SDS; or multiple independent data stores individually accessible through disparate management systems, which may in some implementations be collectively viewed as the SDS. The various storage elements that comprise the physical architecture of the SDS may be centrally located or distributed across a variety of diverse locations.

11. Computer Network

A computer network or like terms are one or more computers in operable communication with each other.

12. Computer Implemented

Computer implemented or like terms refers to one or more steps being actions being performed by a computer, computer system, or computer network.

13. Computer Program Product

A computer program product or like terms refers to product which can be implemented and used on a computer, such as software.

14. Conversion Factor

A conversion factor or like terms as used herein refers to the value that is used to multiply the number of data points (N dp) to get real-time RRi data in milliseconds. The units of the conversion factor are msec per datapoint (“msec/dp”). This conversion factor is obtained by the Hz rate at which the data is collected (dp/sec), taking its reciprocal, which yields sec/dp, then multiplying by 1000 msec/sec to obtain msec·dp. For example, the conversion factor is 1 for data collected at 1000 Hz (reciprocal of 1000 dp/sec is 0.001 sec/dp, times 1000 msec/sec yields 1 msec/dp), 2 for data collected at 500 Hz (reciprocal of 500 dp/sec is 0.002 sec/dp, times 1000 msec/sec yields 2 msec/dp), and 5.345 for data collected at 187 Hz (reciprocal of 187 dp/sec is 0.00535 sec/dp, times 1000 msec/sec yields 5.345 msec/dp). When the conversion factor (msec/dp) is multiplied by the number of data points (dp), the resultant value is msec.

15. Data Series

A data series as any set of data, such as RR interval data points, RRi interval data values or such.

16. Descretization Error

The error resulting from the fact that a function of a continuous variable is represented in the computer by a finite number of evaluations (“samplings”, “data points”). Since the analog signal, for example, and ECG, may continue to change during the time interval between taking one sample and the next, the sampled (or “digitized”) version of the analog signal can never be as accurate as the original analog signal. The difference between the actual analog signal and its digitized version is termed “descretization error” or “discretization error.” This error can be reduced by increasing the rate at which samples are obtained (the “digitization rate” or “sampling rate”) Of extreme importance is the fact that significant events (such as the peak of a QRS complex in an ECG) may occur during the time period between samples. Accordingly, the time of that event has to be assigned to either the sample preceding or following the event, and can thus be off by as much as ½ of the time interval between samples. For example, for a sampling rate of 500/sec, where each sample is 2 msec apart, if the QRS peak were to occur exactly in the middle, the time assigned to the peak would be off by 1 msec from when it actually occurred.

17. Digitized Electrocardiogram (ECG)

A digitized electrocardiogram refers to an ECG that has been produced by digitizing the analog data of an ECG.

18. Identification of a Clinical State

A clinical state is for example, alive, dead, healthy, sick, dying, stable etc. The identification of a clinical state, refers to determining at a moment in time, what clinical state a subject is in. In certain embodiments, one can determine what clinical state a subject will likely be in.

19. Lower the Level of Noise

The noise refers to the amplitude of random noise within data. It can be large spikes superimposed on the real data (large outliers) or small low-level random noise superimposed on the real RRi. Lowering the noise refers to reducing the amplitude of the random noise added at each data point.

20. Material

Material is the tangible part of something (chemical, biological, or mixed) that goes into the makeup of a physical object.

21. Nonlinear Analysis

A nonlinear analysis is based on a nonlinear mathematical model and it is usually considered vis a vie a linear stochastic (statistical) model. Through modern usage it has come to mean a deterministic model of any exponent that is not a probabilistic model with an exponent of 1 (linear). An example of a nonlinear analysis is an analysis using the PD2i algorithm.

22. Obtaining

Obtaining as used in the context of data or values, such as biological and physical data or values refers to acquiring this data or values. It can be acquired, by for example, collection, such as through a machine, such as an ECG. It can also be acquired by downloading or getting data that has already been collected, and for example, stored in a way in which it can be retrieved at a later time.

23. Outputting Results

Outputting or like terms means an analytical result after processing data by an algorithm, i.e. PD2i.

24. Or

The word “or” or like terms as used herein means any one member of a particular list and also includes any combination of members of that list.

25. Optional

“Optional” or “optionally” or like terms means that the subsequently described event or circumstance can or cannot occur, and that the description includes instances where the event or circumstance occurs and instances where it does not. For example, the phrase “optionally the composition can comprise a combination” means that the composition may comprise a combination of different molecules or may not include a combination such that the description includes both the combination and the absence of the combination (i.e., individual members of the combination).

26. Optimizing

Optimizing refers to a process of making better or checking to see if it something or some process can be made better.

27. PD2i Algorithm

PD2i “scales as” ∝ log C(n, r, nref*)/log-R where ∝ means “scales as,” C is the count of vector difference lengths within a step size of R in the correlation integral for PD2i in which n equals the data length, r equals the scaling range, and nref* equals a location of the reference vector for estimating the scaling region slope of log C/log r in a restricted small log-R range that is devoid of the effects of non-stationary data.

28. Publications

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

29. Ranges

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

30. R-R Interval (RRi) Data Points

The set of data points that reflects the amount of time between R-wave peaks.

31. Real-Time R-R Interval (RRi) Values

An actual real-time R-R interval value refers to the real-time between consecutive R-wave peaks, typically provided in milliseconds. A real-time R-R interval is given in a time unit. A real-time R-R interval is obtained by first counting the number of data points between R-wave peaks (see Defn 28) observed in the digitized (samples) data from an ECG and then multiplying each point count by a conversion factor that converts the point count to a real-time value. For example, if the digitization (sampling) rate occurs at 500 Hz, i.e. 500 data points produced per second, and R wave peaks are occurring every 1 second, then there will be approximately 500 data points between R-wave peaks, which when turned to a real-time R-R interval would require multiplying the 500 data points by conversion factor of 2 msec/data-point to yield 1000 milliseconds (1 second). This conversion factor is actually the sampling period (i.e., the amount of time in each data point at that frequency of digitization), which is the reciprocal of the sampling rate.

32. RRi Interval Value

The RRi interval value is the number (N) of data points (dp) between the R waves. If you multiply the N(dp) by the sampling period you get the real-time RRi value.

33. Sample

By sample or like terms is meant an animal, a plant, a fungus, etc.; a natural product, a natural product extract, etc.; a tissue or organ from an animal; a cell (either within a subject, taken directly from a subject, or a cell maintained in culture or from a cultured cell line); a cell lysate (or lysate fraction) or cell extract; or a solution containing one or more molecules derived from a cell or cellular material (e.g. a polypeptide or nucleic acid), which is assayed as described herein. A sample may also be any body fluid or excretion (for example, but not limited to, blood, urine, stool, saliva, tears, bile) that contains cells or cell components.

34. Sampling Period

The sampling period refers to the sample and hold time of each time interval of the digitizer. Also see Real-time R-R Interval above.

35. Subject

As used throughout, by a subject or like terms is meant an individual. Thus, the “subject” can include, for example, domesticated animals, such as cats, dogs, etc., livestock (e.g., cattle, horses, pigs, sheep, goats, etc.), laboratory animals (e.g., mouse, rabbit, rat, guinea pig, etc.) and mammals, non-human mammals, primates, non-human primates, rodents, birds, reptiles, amphibians, fish, and any other animal. In one aspect, the subject is a mammal such as a primate or a human. The subject can be a non-human.

36. Systems

A system or like terms as used herein refers to an interdependent group of items forming a unified whole. For example, a computer system are the parts, such as a process, a memory storage device, and other parts which can be used to form a functioning computer.

37. Underlying Data

The underlying data refers to the data that an RRi is produced from.

38. Values

Specific and preferred values disclosed for components, ingredients, additives, cell types, markers, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

Thus, the disclosed methods, compositions, articles, and machines, can be combined in a manner to comprise, consist of, or consist essentially of, the various components, steps, molecules, and composition, and the like, discussed herein. They can be used, for example, in methods for characterizing a molecule including a ligand as defined herein; a method of producing an index as defined herein; or a method of drug discovery as defined herein.

### VI. EXAMPLES

### A. Example 1

The applicant performed a study to show the accuracy of the new method in nonlinear analysis using data point counts rather than real-time values as the data for the analysis.

There were a total of 20 deaths among the 325 wounded soldiers. With conventional triage using vital signs, 6 soldiers were triaged as having potentially life threatening injuries and therefore received a life-saving intervention (LSI). The other 14 soldiers were not triaged correctly and therefore did not receive life-saving intervention. PD2i analysis by data-point counts, rather than real-time values, resulted in the correct triage of these 14. The real-time values were divided by the sampling time, e.g. 1× for 1000 Hz, 2× for 500 Hz, and 5.345× for 187 Hz, before the PD2i analysis. The division of the real-times values decreases the level of noise. The reduction of noise using this type of analysis resulted in accurate triage of life-threatening conditions in all 20 soldiers, with there being no rejection of files due to noise content.

TABLE 1
PD2i of data-points between R-wave peaks in a study of
325 injured soldiers

| | Dead/No LSI | Dead/LSI | Total |
|---|---|---|---|
| PD2i < 1 | 14 (100%) | 4 (67%) | 18 |
| PD2i ≧ 1 | 0 (0%) | 2 (33%) | 2 |
| | 14 | 6 | 20 |

We claim:

1. A method of detecting or predicting clinical outcomes, comprising the steps of:
a. obtaining real-time R-R interval (RRi) values in milliseconds,
b. producing a first data point series by dividing the real-time RRi values by the sampling period,
c. analyzing the first data point series using nonlinear analysis producing analyzed data; and
d. using the analyzed data to detect or predict clinical outcomes.

2. A method of detecting or predicting clinical outcomes, comprising the steps of:
a. obtaining R-R interval (RRi) data points,
b. analyzing the data points using nonlinear analysis producing analyzed data before the RRi values are multiplied by the sampling period to become a real-time RRi value in milliseconds; and
c. using the analyzed data to detect or predict clinical outcomes.

3. A method to lower the level of noise in data used for detecting or predicting clinical outcomes, comprising the steps of:
a. obtaining R-R interval (RRi) data points,
b. analyzing the data points using nonlinear analysis producing an analyzed data before the RRi interval values are multiplied by the sampling period to become a real-time RRi interval values in milliseconds; and
c. using the analyzed data to detect or predict clinical outcomes.

4. A method of performing a nonlinear analysis for identification of a clinical state, comprising:
a. obtaining R-R interval (RRi) data points,
b. analyzing the R-R interval data points using a nonlinear analysis producing analyzed data before the RRi data points are converted to a real-time RRi values in milliseconds;
c. using the analyzed data to identify a clinical state.

5. The method of claims 1-9, wherein the clinical outcome is cardiac death.

6. The method of claims 1-9, wherein underlying data for the RRi came from a digitized electrocardiogram (ECG).

7. The method of claims 1-9, wherein the nonlinear analysis comprises analysis with a PD2i algorithm.

8. The method of claims 1-9, wherein the RRi data is 187 Hz.

9. The method of claims 1-9, wherein the RRi data is 500 Hz.

10. The method of claims 1-9, wherein the method is a computer implemented method.

11. The method of claim 10, further comprising the step of outputting results from the nonlinear analysis.

12. A method of analyzing a subject's biological data comprising; receiving a biological record, wherein the record contains an RRi; analyzing the RRi using a nonlinear analysis and outputting results from the nonlinear analysis.

13. The method of claim 12, wherein the method is a computer implemented method.

14. The method of claim 12, wherein receiving the biological record comprises receiving the biological record from a storage medium.

15. The method of claim 12, wherein receiving the biological record comprises receiving the record from a computer system.

16. The method of claim 12, wherein receiving the biological record comprises receiving the record from a biological system.

17. The method of claim 12, wherein receiving the biological record comprises receiving the biological record via a computer network.

18. The method of claims 12-17, wherein the record comprises an ECG record or a respiratory record.

19. A method of analyzing the variation in biological or physical data of a subject comprising, recommending the performance of methods in claim 12 to be performed.

20. A method comprising the steps of receiving an output from any of claims 10-19 and identifying a subject having a nonlinear analysis indicating a biological anomaly.

21. One or more computer readable media storing program code that, upon execution by one or more computer systems, causes the computer systems to perform the method of claim 12.

22. A computer program product comprising a computer usable memory adapted to be executed to implement the method of claim 12.

23. The computer program of claim 12, comprising a logic processing module, a configuration file processing module, a data organization module, and data display organization module, that are embodied upon a computer readable medium.

24. A computer program product, comprising a computer usable medium having a computer readable program code embodied therein, said computer readable program code adapted to be executed to implement a method for generating the nonlinear analysis of claims 12-22, said method further comprising: providing a system, wherein the system comprises distinct software modules, and wherein the distinct software modules comprise a logic processing module, a configuration file processing module, a data organization module, and a data display organization module.

25. The method of claim 12, further comprising a computerized system configured for performing the method.

26. The method of claim 12, further comprising the outputting of the results from the nonlinear analysis.

27. A computer-readable medium having stored thereon instructions that, when executed on a programmed processor perform the methods of claim 12.

28. A system, the system comprising: a data store capable of storing biological data; a system processor comprising one or more processing elements, the one or more processing elements programmed or adapted to: receive biological data comprising RRi; store the biological data in the data store; perform a nonlinear analysis on the biological data before the data is converted to real-time data; and outputting of the results from the nonlinear analysis.

29. The system of claim 28, wherein the system receives the biological data from an ECG system.

30. The system of claim 28, wherein the system receives the biological data via a computer network.

31. The system of claim 28, wherein the biological data is ECG data.

32. The system of claim 28, wherein the system is an ECG system.
